(19) United States
(12) Patent Application Publication
(10) Pub. No.: US 2012/0058306 A1
(43) Pub. Date: Mar. 8, 2012

(54) GLASS SUBSTRATE AND METHOD FOR PRODUCING SAME

(76) Inventors: Shinkichi Miwa, Shiga (JP); Tomoki Yanase, Shiga (JP)

(21) Appl. No.: 13/319,128

(22) PCT Filed: May 7, 2010
(86) PCT No.: PCT/JP2010/057799

§ 371 Date: Nov. 7, 2011

(30) Foreign Application Priority Data
May 7, 2009 (JP) 2009-112435

(51) Int. Cl. B32B 17/00; C03C 15/00; B32B 33/00

(52) U.S. Cl. 428/141; 216/67

(57) ABSTRACT

A glass substrate comprises a first surface and a second surface. The first surface has an average surface roughness Ra of 0.2 nm or less, and the second surface has an average surface roughness Ra of 0.3 to 1.5 nm. At least the second surface is subjected to chemical treatment through atmospheric pressure plasma processing.

### TECHNICAL FIELD

The present invention relates to a glass substrate which has less incidence of electrostatic charging even by contacting and peeling occurred, and a method of producing the same, or to a glass substrate which does not easily adhere to another glass substrate or a member such as a plate (surface plate or stage) even if both the glass substrates are in contact to each other or the glass substrate is in contact to the member, and a method of producing the same.

### BACKGROUND ART

A glass substrate is widely used as a substrate for a flat panel display such as a liquid crystal display (LCD). Further, for flat panel displays, in particular, for the LCD or an OLED display, an alkali-free glass substrates substantially free of alkali metal oxides is used.

In such applications as above, the alkali-free glass substrate is required to have the characteristics of (1) having excellent chemical resistance, specifically having excellent resistance to chemical liquids such as various acids and alkalis used in a photolitho-etching step and (2) having a high strain point, specifically a strain point of 600° C. or more, to prevent the thermal shrinkage of the glass substrate.

In a film forming step, an annealing step, and the like for producing a flat panel display, the glass substrate is heated to several hundred degrees C. At present, when a polycrystalline silicon TFT-LCD is produced, the temperature in each of the above-mentioned steps is about 400 to 600° C. The glass substrate used in this case is required to have a high strain point, specifically a strain point of 600° C. or more.

In order to produce an alkali-free glass substrate having a larger area and a smaller thickness efficiently, glass is required to have the characteristics of (3) having excellent meltability to suppress melt defects such as bubbles, stones, and cords in glass and (4) having excellent denitrification resistance to avoid contamination of foreign substances generated during the process of melting or forming in a glass substrate.

### CITATION LIST

### Patent Document

Patent Document 1: JP 2001-343632 A

Patent Document 2: JP 2002-72922 A

### SUMMARY OF INVENTION

### Technical Problem

An alkali-free glass substrate frequently has the problem of electrostatic charging. Glass, which is an insulator, is very likely to be charged. In particular, alkali-free glass substantially free of alkali metal oxides is apt to be charged and once charged static electricity tends to be kept in the glass. Charging of a glass substrate is caused in various steps of the production process of a LCD, an OLED display, or the like. In particular, a present major issue is so-called peeling electrostatic charging, which occurs due to contacting and peeling between a glass substrate and a metal plate or an insulator plate in a film forming step or the like. Electrostatic charging due to contacting and peeling between a glass substrate and a plate occurs not only in a step performed in the air under normal pressure but also in a vacuum step such as a step of etching a thin film on a surface of a glass substrate or a film forming step, resulting in causing some problems. When an electrically-conductive substance comes close to a glass substrate charged in those steps, discharge is induced. The voltage of charged static electricity reaches as high as several ten kV, and hence the discharge causes the break of a device or an electrode wire on a surface of the glass substrate, or occasionally causes the break (insulation breakdown or electrostatic breakdown) of glass itself, resulting in the occurrence of display defects. When an active matrix type LCD typified by a TFT-LCD among LCDs is produced, a microscopic semiconductor device such as a thin-film transistor and an electronic circuit are formed on a surface of a glass substrate. Since such the device and the circuit are very vulnerable to electrostatic breakdown, particularly serious problems occur in them. Moreover, a charged glass substrate attracts dust in a surrounding environment, which causes the contamination of the surfaces of the glass substrate.

Besides, since a glass substrate having a smooth surface easily adheres to a metal or ceramic plate, when the glass substrate is peeled off from the plate, the glass substrate may be damaged, which raises an additional problem. Charging of the glass substrate or the plate also affects this adhesion.

There is frequently used, as an antistatic method for a glass substrate, a method including neutralizing a charge by using an ionizer, a method including discharging an accumulated charge into the air by increasing the humidity in the surrounding environment, or the like. However, these antistatic methods cause an increase in production cost, and moreover, electrification occurs at various places in the production process, and hence there remains a problem in that it is difficult to work out an effective countermeasure. Besides, these antistatic methods cannot be applied in a vacuum step such as a plasma etching step or a film forming step. Thus, it is strongly demanded to develop a glass substrate which has less incidence of electrostatic charging even in a vacuum step, for use in a flat panel display such as a LCD and an OLED display (see Patent Documents 1 and 2).

On the other hand, the surface of a glass substrate, the surface being located on the side not contacting to various plates, is desired to have high surface accuracy. This surface is called, in general, a preferentially guaranteed surface of a glass substrate or is simply called its “front surface.” For example, in the production process of a thin-film transistor type LCD, various wiring films and devices for driving pixels are formed as thin films on the preferentially guaranteed surface of a glass substrate. If the preferentially guaranteed surface of a glass substrate has flaws, stains or large irregularities, a wiring film may be broken, or a TFT may be poorly formed, etc., causing display defects. Thus, for an IPS system LCD or an ultra high-definition LCD which attracts attention as a wide viewing angle technology for TV, demand criteria for flaws or stains in the preferentially guaranteed surface of a glass substrate are set to a very high level. Further, for an OLED display which attracts attention as a next-generation display, a high-definition drive circuit using a low-temperature p-Si (LIPS) is formed on the preferentially guaranteed surface of a glass substrate, and hence it is becoming very important for the preferentially guaranteed surface of a glass substrate to have good smoothness.

A technical object of the present invention therefore is to provide a glass substrate which has less incidence of electrostatic charging, does not easily adhere to a plate, and is capable of suppressing the breaking of a wiring film, poor formation of a TFT, and the like in the production processes of various displays.

### Solution to Problem

The inventors of the present invention have made intensive studies, and as a result, have found that the above-mentioned technical object can be achieved by controlling, within a predetermined range, the average surface roughnesses Ra of both the surfaces excluding edge surfaces of a glass substrate and by subjecting at least one surface of the glass substrate to chemical treatment through atmospheric pressure plasma processing, thus proposing the finding as the present invention. That is, a glass substrate of the present invention comprises a first surface and a second surface, wherein the first surface has an average surface roughness Ra of 0.2 nm or less, and at least the second surface is subjected to chemical treatment through atmospheric pressure plasma processing so that the second surface has an average surface roughness Ra of 0.3 to 1.5 nm. Note that the term “first surface” refers to one surface excluding edge surfaces of the glass substrate, and the term “second surface” refers to another surface excluding the edge surfaces of the glass substrate.

A means for decreasing microscopically the contact area between a glass substrate and a plate is the most effective for decreasing charging a glass substrate, in particular, peeling electrostatic charging of a glass substrate and adhesion between a glass substrate and a plate. When a glass substrate and a plate are brought into contact with a strong force, electrons are transferred through the interface between the both. Then, peeling between the both causes charging. By controlling the average surface roughness Ra of the second surface of the glass substrate within a proper range, the contact area between the glass substrate and the plate can be decreased, thereby the amount of charging can be reduced. Further, a glass substrate which is likely to be electrically charged and has very high surface smoothness has a feature of easily adhering to a plate when sucking the glass substrate to the plate. By controlling the average surface roughness Ra of the second surface of the glass substrate within a proper range, the contact area between the glass substrate and the plate can be decreased, thereby the glass substrate can be prevented from adhering to the plate.

As the average surface roughness Ra of the second surface of the glass substrate is larger, it becomes easier to prevent peeling electrostatic charging of the glass substrate and adhesion of the glass substrate to the plate. However, if the average surface roughness Ra of the second surface of the glass substrate is too large, the surface strength of the glass substrate may be impaired, and moreover, the surfaces of the glass substrate are further eroded in a chemical treatment step in the production process of various displays. As a result, defects may occur in the display of various displays. Besides, if the average surface roughness Ra of the second surface of the glass substrate is too large, the process cost of chemical treatment raises and additional defects such as contamination of the glass substrate are likely to be caused. Thus, when the average surface roughness Ra of the second surface of the glass substrate is controlled to 0.3 to 1.5 nm, the strength or the like of the glass substrate can be suppressed while preventing the glass substrate from peeling electrostatic charging, adhesion and the like effectively, without excessive raise of the process cost. Here, it is adequate that 70% or more of the second surface (or the first surface) of the glass substrate has an “average surface roughness Ra” within the predetermined range. In addition, the average surface roughness Ra is preferably determined by averaging the values of average surface roughness Ra measured at a plurality of portions on the second surface (or the first surface). For example, even if, at a particular portion on the second surface of a glass substrate (such as peripheral portions, corner portions, etc. of the glass substrate), the average surface roughness Ra is larger than 1.5 nm or, in reverse, is smaller than 0.3 nm, when 70% or more, preferably 80% or more of the second surface of the glass substrate has an average surface roughness Ra within the predetermined range, expected advantages according to the present invention can be obtained.

In the glass substrate of the present invention, at least the second surface of the glass substrate is subjected to chemical treatment through atmospheric pressure plasma processing. As a means for roughing a surface of a glass substrate, chemical treatment with using a chemical liquid such as hydrofluoric acid or the like may be employed, besides atmospheric pressure plasma processing. This chemical treatment can be carried out at a relatively low cost through a simple process, but it is necessary to care about the influence of scattering of a chemical liquid or the like during the treatment on the preferentially guaranteed surface of a glass substrate and the problem of insufficient safety in a work environment. Further, in recent years, the size of a glass substrate for a LCD has been more than 2 m square. However, it is very difficult to apply chemical treatment uniformly to a glass substrate having a large area through a wet process such as chemical liquid treatment. On the other hand, atmospheric pressure plasma processing is a dry process, so that chemical treatment can be applied to a glass substrate having a large area and a thin thickness uniformly and efficiently, although possibly leading to a higher initial cost of its apparatus. Thus, the atmospheric pressure plasma processing is the most suitable process for such glass substrate. Moreover, the atmospheric pressure plasma processing can avoid the influence of scattering of a chemical liquid or the like during chemical treatment on the preferentially guaranteed surface of the glass substrate and can solve the problem of insufficient safety in a work environment. Note that, when general mechanical polishing is employed, not only the average surface roughness Ra of a surface of a glass substrate becomes larger, but also minute cracks so called latent flaws are generated in the surface of the glass substrate, which may cause breaking of a wire or may cause strength reduction of the glass substrate. However, such problems do not occur in atmospheric pressure plasma processing, and hence strength reduction of a glass substrate can be prevented as much as possible.

In the glass substrate of the present invention, the average surface roughness Ra of the first surface is controlled to 0.2 nm or less. Thereby, various wiring films and devices for driving pixels can be formed on the surface of the glass substrate with a high degree of accuracy, resulting in being able to prevent breaking of a thin wiring film, poor formation of a TFT, and the like in an appropriate manner.

In the glass substrate of the present invention, the atmospheric pressure plasma processing preferably uses a gas containing F as a source. Thereby, a plasma containing an HF-based gas can be generated and this plasma can be used for etching the surface of the glass substrate.

The glass substrate of the present invention is preferably formed by a down-draw method.

In the glass substrate of the present invention, an area of each of the first surface and the second surface is preferably more than 0.2 m².

The glass substrate of the present invention preferably has a thickness of 0.5 mm or less.

The glass substrate of the present invention preferably comprises, as a glass composition in terms of oxides by mass%, 50 to 70% of SiO₂, 10 to 20% of Al₂O₃, 0 to 15% of B₂O₃, 1 to 30% of MgO+CaO+SrO+BaO, 0 to 10% of MgO, 0 to 20% of CaO, 0 to 20% of SrO, and 0 to 20% of BaO, and is substantially free of alkali metal oxides. Here, the phrase “is substantially free of alkali metal oxides” means that the content of alkali metal oxides is 1000 ppm or less in the glass composition.

In the glass substrate of the present invention, the first surface may be a surface on which an electrode wire or a device is formed, while the second surface may be a surface on which electrode wires and device is not formed. Thereby, various wiring films and devices for driving pixels can be formed on the second surface of the glass substrate with a high degree of accuracy while preventing the glass substrate from charging or adhesion to a plate during production.

A method of producing a glass substrate having a first surface and a second surface, according to the present invention, comprises the steps of forming the glass substrate having the first surface and the second surface, and subjecting at lease the second surface to chemical treatment through atmospheric pressure plasma processing so that the first surface has an average surface roughness Ra of 0.2 nm or less, and the second surface has an average surface roughness Ra of 0.3 to 1.5 nm.

In the method of producing a glass substrate according to the present invention, the atmospheric pressure plasma processing preferably uses a gas containing F as a source. Thereby, a plasma containing an HF-based gas can be generated and this plasma can be used for etching the surface of the glass substrate.

In the method of producing a glass substrate according to the present invention, it is preferable that a CF₄ gas or an SF₆ gas is used as the gas containing F. Thereby, a plasma containing an HF-based gas can be efficiently generated and this plasma can be used for properly etching the surface of the glass substrate.

In the method of producing a glass substrate according to the present invention, the atmospheric pressure plasma processing is preferably carried out at a treatment speed of 0.5 to 10 m/minute. Thereby, the production efficiency of the glass substrate can be enhanced while the chemical treatment is properly applied to the second surface of the glass substrate.

In the method of producing a glass substrate according to the present invention, the second surface preferably has an average surface roughness Ra of 0.2 nm or less before the chemical treatment. Thereby, the chemical treatment can be uniformly applied to the second surface of the glass substrate.

In the method of producing a glass substrate according to the present invention, the first surface may be a surface on which an electrode wire or a device is formed, while the second surface may be a surface on which electrode wire or device is not formed.

### Advantageous Effects of Invention

The glass substrate according to the present invention is decreased in amount of peeling electrostatic charging and therefore is capable of suppressing electrostatic charging generated in the production process of a LCD, an OLED display, or the like. Thus, devices or wirings on the glass substrate can be prevented from breaking, resulting in the enhancement of the production efficiency of a LCD, an OLED display, or the like. Further, the glass substrate according to the present invention does not easily adhere to a plate in the production process of a LCD, an OLED display, or the like, and hence the trouble with breaking of the glass substrate can be avoided. Therefore, the glass substrate according to the present invention is suitable for a substrate used for various electronic devices, for example, a flat panel display such as a LCD or an OLED display.

### BRIEF DESCRIPTION OF DRAWINGS

FIG. 1(a) is an explanatory diagram showing a state in which a glass substrate is placed in an apparatus for measuring the amount of peeling electrostatic charging.

FIG. 1(b) is an explanatory diagram showing a state in which the glass substrate and a plate contact with each other in the apparatus for measuring the amount of peeling electrostatic charging.

### DESCRIPTION OF EMBODIMENTS

In a glass substrate of the present invention, the average surface roughness Ra of a second surface is 0.3 to 1.5 nm, preferably 0.4 to 1.2 nm, more preferably 0.5 to 1.0 nm, still more preferably 0.5 to less than 0.8 nm. As the average surface roughness Ra of the second surface of the glass substrate is larger, the amount of charging tends to be smaller, but if the average surface roughness Ra is too large, large defects are likely to be generated on the surface of the glass substrate, and hence the strength of the glass substrate is apt to lower. Further, as the average surface roughness Ra is larger, it takes more time and cost to perform chemical treatment, resulting in raise of the production cost of the glass substrate. Thus, it is necessary to prevent the glass substrate from charging and adhesion by controlling the average surface roughness Ra of the second surface of the glass substrate within a proper range, while preventing strength reduction of the glass substrate, without involving a productivity decline.

For the glass substrate of the present invention, it is preferred to use a gas containing F such as a CF₄ gas or an SF₆ gas as a source in atmospheric pressure plasma processing. With this, it becomes easier to control the average surface roughness Ra of the glass substrate within a predetermined range. Atmospheric pressure plasma processing has been used for surface modification of an organic film, removal of organic stains on the surfaces of a glass substrate for a display or the like, and so on. However, the conventional atmospheric pressure plasma processing used an Ar gas or a N₂ gas as a source, and therefore was not able to make the average surface roughness Ra of a glass substrate large. When a gas containing F such as a CF₄ gas or a SF₆ gas is used as a source and any of these gasses is mixed with H₂O, followed by reaction with a plasma, a plasma containing a HF-based gas is generated. With this plasma, applying chemical treatment to a surface of a glass substrate, the glass substrate can have a larger average surface roughness Ra. Note that in atmospheric pressure plasma processing, it is preferred to use, in practical production, a treatment gas (+plasma) prepared by mixing any of those gases containing F with a carrier gas such as Ar.

The treatment time of atmospheric pressure plasma processing is preferably 0.5 second or more and 5 minutes or less, and the treatment speed is preferably 0.5 to 10 m/minute. With this, the average surface roughness Ra of the glass substrate is easily controlled within a predetermined range in a short time.

The glass substrate of the present invention is formed preferably by a down-draw method, particularly preferably by an overflow down-draw method. With this, it is possible to form efficiently a glass substrate having a large area and a good surface accuracy. Further, in the glass substrate of the present invention, the first surface and the second surface before chemical treatment are each preferably an as-formed surface (fire-polished surface). With this, the production process of the glass substrate can be simplified, thereby being able to reduce the production cost of the glass substrate. At present, among various down-draw methods, an overflow down-draw method is the most suitable method from the above-mentioned standpoint. As for other forming methods, in a float method, for example, the surfaces of the resultant glass substrate are contaminated by molten tin, and also minute surface irregularities called waviness degrade display performance of a TFT-LCD. Therefore, the resultant glass substrate must be polished the preferentially guaranteed surface to make a finished product. In contrast, in the overflow down-draw method, the above-mentioned troubles are not likely to occur, and hence a polishing step can be eliminated, resulting in the reduction of the production cost of the glass substrate.

As the glass substrate of the present invention has a larger area, it exerts a larger effect. This is because a glass substrate having a large area tends to store static electricity to be electrically charged, and when the glass substrate adheres to a plate, the glass substrate is apt to break in subsequent steps such as lift-up. Thus, in the glass substrate of the present invention, the first surface and the second surface each have an area of preferably 0.2 m² or more, 0.5 m² or more, or 0.6 m² or more, particularly preferably 1.0 m² or more.

As the glass substrate of the present invention has a smaller thickness, it exerts a larger effect. This is because a glass substrate having a small thickness is apt to break in subsequent steps such as lift-up when the glass substrate adheres to a plate. Thus, in the glass substrate of the present invention, the first surface and the second surface each preferably have a thickness of 0.7 mm or less, 0.6 mm or less, 0.5 mm or less, and particularly preferably have a thickness of 0.4 mm or less.

It is preferred that the glass substrate of the present invention comprises, as a glass composition in terms of oxides by mass%, 50 to 70% of SiO₂, 10 to 20% of Al₂O₃, 0 to 15% of B₂O₃, 1 to 25% of MgO+CaO+SrO+BaO, 0 to 10% of MgO, 0 to 20% of CaO, 0 to 20% of SrO, and 0 to 20% of BaO, and be substantially free of alkali metal oxides. The reasons why the content of each component in the glass composition is limited as described above are shown below.

The content of SiO₂ is 50 to 70%, preferably 55 to 65%. When the content of SiO₂ is small, the heat resistance of glass, the acid resistance, and the like lower. On the other hand, when the content of SiO₂ is large, the viscosity of glass becomes high, the meltability lowers, and moreover, defects such as devitrified crystals (cristobalite) are apt to be generated in the glass.

The content of Al₂O₃ is 10 to 25%, preferably 12% to 23%, more preferably 13% to 20%. When the content of Al₂O₃ is smaller than 10%, it becomes difficult to enhance the heat resistance of glass. Further, Al₂O₃ has the function of increasing the Young's modulus and the specific Young's modulus, and when the content of Al₂O₃ is smaller than 10%, the Young's modulus and the specific Young's modulus tend to lower. Note that if the specific Young's modulus lowers, the deflection amount of the resultant glass substrate becomes larger. Particularly, in a glass substrate having a large area, the deflection amount becomes remarkably larger. On the other hand, when the content of Al₂O₃ in a glass substrate is larger than 25%, a reaction product is easily produced in a surface of the glass substrate through atmospheric pressure plasma processing, and as a result, the surface roughness of the glass substrate is apt to vary in the atmospheric pressure plasma processing.

B₂O₃ is a component that functions as a melting agent, reduces the viscosity, and enhances the meltability. The content of B₂O₃ is 0 to 15%, preferably 1 to 13%. When the content of B₂O₃ is small, its function as a melting agent becomes insufficient, the viscosity becomes higher, and bubble-less quality of the glass substrate is apt to lower. On the other hand, when the content of B₂O₃ is large, it becomes difficult to apply chemical treatment to a surface of the resultant glass substrate through atmospheric pressure plasma processing. Further, when the content of B₂O₃ is large, the heat resistance and the Young's modulus are apt to lower.

MgO+CaO+SrO+BaO are components that lower the liquidus temperature of glass and suppress the generation of crystal inclusions in glass, and also enhance the meltability and the formability. The content thereof is 1 to 25%, preferably 5 to 20%, more preferably 10 to 20%. When the content of MgO+CaO+SrO+BaO is small in glass, it becomes difficult to apply chemical treatment to a surface of the resultant glass substrate through atmospheric pressure plasma processing, and MgO+CaO+SrO+BaO cannot sufficiently function as a melting agent, resulting in the reduction of the meltability of the glass. On the other hand, when the content of MgO+CaO+SrO+BaO is too large, the density rises and the specific Young's modulus lowers.

MgO is a component that lowers the viscosity of glass and enhances the meltability without lowering the strain point. Further, MgO is a component that has the effect of lowering the density most significantly, among alkaline-earth metal oxides. The content thereof is 0 to 10%, preferably 0 to 8%, more preferably 0 to 6%, still more preferably 0 to 5%, most preferably 0 to 3%. However, when the content of MgO is larger, the liquidus temperature rises and the devitrification resistance is apt to lower.

CaO is a component that lowers the viscosity of glass and remarkably enhances the meltability without lowering the strain point. Further, CaO has a higher effect of suppressing the devitrification compared with other components in the glass composition system according to the present invention, and when the content of CaO is relatively increased in the total content of alkaline-earth metal oxides, glass having a low density can be easily provided. When the content of CaO is large, the thermal expansion coefficient and the density excessively rise, and the balance of components in the composition of the resultant glass is lost, with the result that the devitrification resistance is apt to lower inversely. Thus, the content of CaO is 0 to 20%, preferably 0 to 15%, more preferably 1 to 10%.

SrO and BaO are components that lower the viscosity of glass and enhance the meltability without lowering the strain point. However, when the content of each of SrO and BaO is large, the density and the thermal expansion coefficient are likely to rise. The content of SrO is 0 to 20%, preferably 0 to 15%, more preferably 0 to 10%. Further, the content of BaO is 0 to 20%, preferably 0 to 15%.

In addition to the above-mentioned components, the glass composition may include other components at a total content of up to 10%, preferably up to 5%.

ZrO₂ is a component that increases the Young's modulus of glass, and its content is preferably 0 to 5%, 0 to 3%, or 0 to 0.5%, particularly preferably 0 to 0.2%. When the content of ZrO₂ is large, the liquidus temperature rises and devitrified crystals of zircon are easily precipitated.

TiO₂ is a component that lowers the viscosity of glass, increases the meltability, and suppresses the solarization, but when TiO₂ is included in a glass composition at a large content, the resultant glass is colored, leading to the reduction of its transmittance. Thus, the content of TiO₂ is preferably 0 to 5%, 0 to 3%, or 0 to 1%, particularly preferably 0 to 0.02%.

P₂O₅ is a component that enhances the denitrification resistance of glass, but when P₂O₅ is included in a glass composition at a large content, phase separation or white turbidity may occur in the resultant glass, and moreover, water resistance remarkably lowers. Thus, the content of P₂O₅ is preferably 0 to 5% or 0 to 1%, particularly preferably 0 to 0.5%.

Y₂O₃, Nb₂O₅, and La₂O₃ are components that have the function of increasing the strain point of glass, the Young's modulus, and the like. However, when the content of these components is larger than 5%, the density tends to increase.

It is possible to add, as a fining agent, SnO₂, F, Cl, SO₃, C, or a metal powder of Al, Si, or the like at up to about 2%. Further, CeO₂ or the like can also be added at up to about 2% as a fining agent.

Halogens such as F and Cl have the effect of promoting the melting of alkali-free glass. Thus, if any of these components is added, the melting temperature can be lowered, actions of a fining agent are promoted, and consequently, a glass production furnace can have a longer service life while the cost of melting glass is decreased.

A method of producing a glass substrate of the present invention comprised the steps of forming the glass substrate having the first surface and the second surface, and subjecting at least the second surface to chemical treatment through atmospheric pressure plasma processing so that the first surface has an average surface roughness Ra of 0.2 nm or less, and the second surface has an average surface roughness Ra of 0.3 to 1.5 nm. Note that the technical features (preferred aspects) of the method of producing a glass substrate of the present invention has already been described in relation to the glass substrate of the present invention, and hence description thereof should be omitted.

### EXAMPLES

[Preparation of Samples]

Table 1 shows each glass composition suitable for the glass substrate of the present invention and characteristics of each glass substrate. Each sample in the table was prepared in the following manner. First, raw glass materials were blended so that each of the glass compositions in the table was attained, and were melted at 1600° C. for 24 hours in a platinum pot. Next, the resultant molten glass was poured on a carbon plate to form into a flat sheet shape. The resultant glass was evaluated for characteristics shown in the table.

TABLE 1

| | | Example | | | | | | | |
|---|---|---|---|---|---|---|---|---|---|
| | | 1 | 2 | 3 | 4 | 5 | 6 | 7 | 8 |
| Glass | SiO₂ | 62.79 | 62.99 | 60.49 | 63.98 | 60.68 | 55.68 | 55.47 | 61.87 |
| composition | Al₂O₃ | 16.0 | 15.0 | 16.5 | 16.0 | 15.0 | 13.0 | 15.5 | 15.0 |
| (mass %) | B₂O₃ | 11.0 | 9.0 | 10.0 | 7.0 | 16.0 | 7.0 | 8.5 | 9.0 |
| | MgO | 1.0 | 0.5 | — | 2.0 | 0.5 | — | — | 0.5 |
| | CaO | 7.5 | 6.0 | 8.0 | 4.0 | 7.5 | 6.0 | 8.0 | 6.0 |
| | SrO | 1.0 | 4.0 | 4.0 | 6.0 | — | 4.0 | 1.0 | 4.0 |
| | BaO | — | 2.0 | 0.5 | 0.6 | — | 14.0 | 11.0 | 2.0 |
| | ZnO | 0.5 | — | — | — | — | — | — | 1.0 |
| | ZrO₂ | — | 0.2 | 0.1 | 0.1 | — | — | — | 0.1 |
| | TiO₂ | — | — | — | — | — | — | — | 0.1 |
| | SnO₂ | 0.2 | 0.3 | 0.3 | 0.3 | 0.3 | 0.3 | 0.5 | 0.3 |
| | Cl | — | — | 0.1 | — | — | — | — | — |
| | Fe₂O₃ | 0.01 | 0.01 | 0.01 | 0.02 | 0.02 | 0.02 | 0.03 | 0.03 |
| | K₂O | — | — | — | — | — | — | — | 0.1 |

| | | | | | | | | |
|---|---|---|---|---|---|---|---|---|
| Density (g/cm³) | 2.4 | 2.5 | 2.5 | 2.5 | 2.3 | 2.7 | 2.6 | 2.6 |
| Thermal expansion | 32 | 37 | 38 | 37 | 33 | 46 | 45 | 38 |
| coefficient (×10⁻⁷/° C.) | | | | | | | | |
| Strain point (° C.) | 665 | 660 | 660 | 670 | 640 | 640 | 655 | 640 |
| Softening point (° C.) | 980 | 950 | 970 | 940 | 940 | 900 | 920 | 930 |
| 10^{2.5} dPa · s (° C.) | 1600 | 1560 | 1530 | 1530 | 1550 | 1500 | 1500 | 1530 |
| Young's modulus (GPa) | 72 | 70 | 73 | 80 | 66 | 75 | 77 | 69 |
| Liquidus temperature | 1100 | 1080 | 1090 | 1120 | 1060 | 1060 | 1030 | 1060 |
| (° C.) | | | | | | | | |
| Liquidus viscosity | 6.0 | 6.0 | 5.8 | 5.4 | 6.0 | 5.5 | 6.0 | 5.6 |
| (log₁₀ηTL) | | | | | | | | |

The density is a value obtained by measurement by the well-known Archimedes method.

The thermal expansion coefficient is an average value over the temperature range of 30 to 380° C. calculated from the values obtained by measurement with a dilatometer.

The strain point is a value obtained by measurement based on the method of ASTM C336.

The softening point is a value obtained by measurement based on the method of ASTM C338.

The temperature corresponding to the viscosity of 10^{2.5} dPa·s is a value obtained by measurement by a platinum sphere pull up method.

The Young's modulus is a value obtained by measurement by a resonance method.

The liquidus temperature is a value obtained by crushing the glass and measuring a temperature at which crystals of glass are deposited after glass powders that passed through a standard 30-mesh sieve (sieve opening: 500 μm) and remained on a 50-mesh sieve (sieve opening: 300 μm) are placed in a platinum boat and kept for 24 hours in a gradient heating furnace.

The liquidus viscosity is a value obtained by measuring the viscosity of glass at a liquidus temperature TL using a platinum sphere pull up method.

Next, Sample No. 3 in Table 1 was melted by using a production facility for practical production, the resultant molten glass was formed into a flat glass sheet with a thickness of 0.4 mm by an overflow down-draw method, and the resultant glass was cut into a piece having a size of 400 by 500 mm, followed by washing, thereby yielding a glass substrate having a quality level appropriate as a glass substrate for a LCD. This glass substrate was used for the evaluation of peeling electrostatic charging and the evaluation of adhesion property.

Table 2 shows the results of the evaluation of peeling electrostatic charging and those of the evaluation of adhesion property. Note that both the surfaces (the first surface and the second surface) of each of Sample Nos. 3-1 to 3-6 in Table 2 were fire-polished surfaces and had an average surface roughness Ra of 0.15 nm.

TABLE 2

| | Comparative | | | | | |
|---|---|---|---|---|---|---|
| | Example | Example | | | | |
| | 3-1 | 3-2 | 3-3 | 3-4 | 3-5 | 3-6 |
| Gas | Without | Ar | Ar | Ar | Ar | Ar |
| | treatment | CF₄ | CF₄ | CF₄ | SF₆ | CF₄ |
| | | H₂O | H₂O | H₂O | H₂O | H₂O |
| Volume ratio of Ar/CF₄ | — | 20 | 20 | 20 | 20 | 10 |
| (or SF₆) | | | | | | |
| Treatment temperature | — | 25 | 25 | 25 | 25 | 25 |
| (° C.) | | | | | | |
| Treatment speed | — | 3 | 6 | 9 | 3 | 20 |
| (m/minute) | | | | | | |
| Average surface | 0.15 | 0.8 | 0.6 | 0.5 | 1.0 | 0.5 |
| roughness Ra (nm) | | | | | | |
| Amount of peeling | 2500 | 1800 | 1400 | 2000 | 1300 | 1600 |
| electrostatic | | | | | | |
| charging (V) | | | | | | |
| Adhesion property | x | ∘ | ∘ | Δ | ∘ | ∘ |

Next, one surface (the second surface) of each glass substrate of Sample Nos. 3-2 to 3-6 was subjected to chemical treatment through atmospheric pressure plasma processing using a CF₄ gas or a SF₆ gas. The conditions of the chemical treatment are as shown in the table. Sample Nos. 3-2 to 3-6 after the chemical treatment were washed with pure water, followed by drying, and the resultant samples were used for the following evaluations. Note that the other surface (the first surface) of each glass substrate of Sample Nos. 3-2 to 3-6 remained unchanged as a fire-polished surface and had an average surface roughness Ra of 0.15 nm.

### [Measurement of Average Surface Roughness Ra]

AFM (D3000 manufactured by Veeco instruments Inc., cantilever: Si) was used to measure each surface roughness Ra of portions having a range of 10 μm square, to thereby calculate an average surface roughness Ra in the portion. Specifically, surface roughnesses Ra were measured at nine portions in the central portion and the peripheral portion (50 mm inside from the edge portion of a glass substrate) of a glass substrate, and their average value was calculated.

### [Evaluation of Peeling Electrostatic Charging]

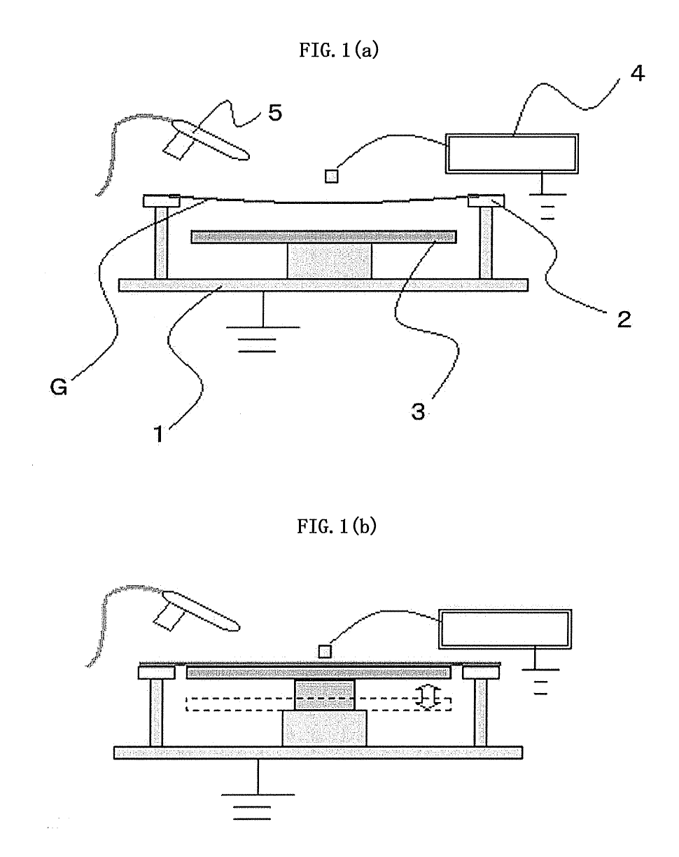

The evaluation of peeling electrostatic charging was performed by using such an apparatus as shown in FIGS. 1. This apparatus has the following construction.

A support 1 for a glass substrate G is provided with pads 2 made of Teflon (registered trademark) for supporting the glass substrate at the four corners. Further, the support 1 is also provided with a plate 3 made of metal aluminum and being movable upward and downward, and it is possible to bring the glass substrate G and the plate 3 into contact to each other and to peel off from each other by moving the plate 3 upward and downward, thereby being able to charge the glass substrate G electrically. Note that the plate 3 is grounded. Further, the plate 3 has formed therein holes (not shown) which are connected to a diaphragm-type vacuum pump (not shown). When the vacuumpump is driven, air is suctioned through the holes of the plate 3, thereby being able to cause the vacuum adsorption of the glass substrate G to the plate 3. Further, an electrostatic voltmeter 4 is provided at a position 10 mm above the glass substrate G, and it is possible to measure continuously the amount of charging generated at the central portion of the glass substrate G by using the electrostatic voltmeter 4. Besides, an air gun 5 with ionizer is provided above the glass substrate G, and the charging of the glass substrate G can be removed by the air gun 5 with ionizer. Note that the plate in this apparatus has a size of 350 by 450 mm.

There is described a method of measuring the amount of peeling electrostatic charging by using this apparatus. Note that an experiment for the measurement is carried out under the environment of a temperature of 20° C.±1° C. and a humidity of 40%±1%. This amount of charging significantly fluctuates by the influence of an atmosphere, in particular, the humidity in the air, and hence it is necessary to care about particularly the control of the humidity.
(1) A glass substrate is placed on the support 1 with its surface subjected to chemical treatment being faced downward.
(2) The air gun 5 with ionizer is used to remove charging so that the glass substrate has a voltage of 10 V or less.
(3) The plate is elevated so as to be brought into contact with the glass substrate, causing vacuum adsorption, thereby attaching the plate to the glass substrate closely for 30 seconds.
(4) The glass substrate is peeled off from the plate by descending the plate, and the electrostatic voltmeter is used to measure continuously the amount of charging generated at the central portion of the glass substrate.
(5) The steps (3) and (4) are repeated and the evaluations of peeling electrostatic charging are continuously performed five times in total.
(6) The maximum amount of charging in each measurement is determined and all the amounts are accumulated, yielding a value which is defined as the amount of peeling electrostatic charging.

### [Evaluation of Adhesion Property]

A glass substrate without chemical treatment (equivalent of Sample No. 3-1) and each of glass substrates subjected to chemical treatment (Sample Nos. 3-2 to 3-6) were overlapped so that the surface without chemical treatment and the surface subjected to chemical treatment faced each other. After that, the overlapped glass substrates were placed on a flat plate, were loaded with a weight of 10 kg uniformly, and were left to stand for 30 minutes. Further, for comparison, Sample No. 3-1 was also evaluated by performing the same method as that described above. Next, both the glass substrates were peeled off from each other. Glass substrates which had been easily peeled off were represented by symbol “∘”. Glass substrates which had not been easily peeled off were represented by symbol “Δ”. Glass substrates which had not been able to be peeled off without the breakage of itself were represented by symbol “×”.

### [Evaluation Results]

As evident from Table 2, in Sample Nos. 3-2 to 3-6, one surface (the first surface) of each glass substrate had an average surface roughness Ra of 0.5 to 1.0 nm, and hence the amount of peeling electrostatic charging was low and the glass substrate did not break when a test for the evaluation of adhesion property was performed. On the other hand, in Sample No. 3-1, the amount of peeling electrostatic charging was high and the glass substrate broke when a test for the evaluation of sticking property was performed. Note that Sample No. 3 in Table 1 was used this time to perform various evaluations, and it is expected that similar evaluation results are also obtained in the case of using any of the other samples (Nos. 1, 2, and 4 to 8).

1. A glass substrate, comprising a first surface and a second surface, wherein:
the first surface has an average surface roughness Ra of 0.2 nm or less;
at least the second surface is subjected to chemical treatment through atmospheric pressure plasma processing so that the second surface has an average surface roughness Ra of 0.3 to 1.5 nm.

2. The glass substrate according to claim 1, wherein the atmospheric pressure plasma processing uses a gas containing F as a source.

3. The glass substrate according to claim 1, which is formed by a down-draw method.

4. The glass substrate according to claim 1, wherein an area of each of the first surface and the second surface is more than 0.2 m².

5. The glass substrate according to claim 1, which has a thickness of 0.5 mm or less.

6. The glass substrate according to claim 1, which comprises, as a glass composition in terms of oxides by mass%, 50 to 70% of SiO₂, 10 to 20% of Al₂O₃, 0 to 15% of B₂O₃, 1 to 30% of MgO+CaO+MgO, 0 to 20% of CaO, 0 to 20% of SrO, and 0 to 20% of BaO, and is substantially free of alkali metal oxides.

7. The glass substrate according to claim 1, wherein:
the first surface is only a surface on which an electrode wire or a device is formed.

8. A method of producing a glass substrate having a first surface and a second surface, the method comprising the steps of:
forming the glass substrate having the first surface and the second surface; and
subjecting at least the second surface to chemical treatment through atmospheric pressure plasma processing so that the first surface has an average surface roughness Ra of 0.2 nm, and the second surface has an average surface roughness Ra of 0.3 to 1.5 nm.

9. The method of producing a glass substrate according to claim 8, wherein the atmospheric pressure plasma processing is carried out by using a gas containing F as a source.

10. The method of producing a glass substrate according to claim 9, wherein a CF₄ gas or an SF₆ gas is used as the gas containing F.

11. The method of producing a glass substrate according to claim 8, wherein the atmospheric pressure plasma processing is carried out at a treatment speed of 0.5 to 10 m/minute.

12. The method of producing a glass substrate according to claim 8, wherein the second surface has an average surface roughness Ra of 0.2 nm or less before the chemical treatment.

13. The method of producing a glass substrate according to claim 8, wherein
the first surface is only a surface on which an electrode wire or a device is formed.

14. The glass substrate according to claim 2, wherein an area of each of the first surface and the second surface is more than 0.2 m².

15. The glass substrate according to claim 3, wherein an area of each of the first surface and the second surface is more than 0.2 m².
